(19) United States
(12) Patent Application Publication
(10) Pub. No.: US 2017/0119227 A1
(43) Pub. Date: May 4, 2017

(54) FLUID DISPENSING CLEANING TOOL

(71) Applicant: 3M INNOVATIVE PROPERTIES COMPANY, St. Paul, MN (US)

(72) Inventor: Matthew D. Chaffee, Minneapolis, MN (US)

(21) Appl. No.: 15/353,313

(22) PCT Filed: May 11, 2015
(86) PCT No.: PCT/US2015/030103

§ 371 Date: Nov. 16, 2016

Related U.S. Application Data
(60) Provisional application No. 62/002,248, filed on May 23, 2014.

(51) Int. Cl. A47L 13/26; B25G 3/16; A47K 11/10

(52) U.S. Cl. CPC A47L 13/26; A47K 11/10; B25G 3/16

(57) ABSTRACT

The disclosed cleaning tool comprises a handle, a cleaning head, a valve, and a locking mechanism. The handle comprises a fluid chamber and a discharge aperture, and the handle has a working end and a holding end. The cleaning head is secured to the working end of the handle and adjacent the discharge aperture. The valve separates the fluid chamber from a discharge aperture and is actuatable between a first open position and a second closed position. In the first open position the fluid chamber is in fluid communication with the discharge aperture. The locking mechanism locks the valve in the open position or the closed position.

### FIELD

The present disclosure relates to a fluid dispensing cleaning tool. In particular, the present disclosure relates to a fluid dispensing cleaning tool with an opening and closing valve for controlling the dispensing of the fluid for cleaning.

### BACKGROUND

Cleaning tools are commonly used for cleaning dishes, bathrooms, walls, showers. These tools can be made of various materials such as foam, sponge, fabric, scrubbing webs and may be attached to a solid, handled tool. Cleaning chemicals are often used with cleaning tools to help with the cleaning process. Some cleaning tools include a cavity for holding solid or liquid cleaning chemicals. Many of these tools have shapes that are restrictive for cleaning on a variety of surfaces or do not easily allow for controlled delivery of the cleaning chemical.

### SUMMARY

The disclosed cleaning tool with a chamber in the handle for holding cleaning chemical includes an actuatable and lockable valve. In one position, the valve allows for fluid flow out of the chamber and in a second position the valve stops fluid flow.

In one embodiment, the cleaning tool comprises a handle comprising a fluid chamber and a discharge aperture, wherein the handle has a working end and a holding end, a cleaning head secured to the working end of the handle and adjacent the discharge aperture, a valve separating the fluid chamber from a discharge aperture, actuatable between a first open position and a second closed position, wherein in the first open position the fluid chamber is in fluid communication with the discharge aperture, and a locking mechanism at the valve and handle to lock the valve in the open position or the closed position.

In one embodiment, the handle extends in a straight line from the holding end to the working end. In one embodiment, the handle further comprises an actuator for displacing fluid from within the fluid chamber. In one embodiment, the discharge aperture is located on the handle and removed from the cleaning head. In one embodiment, the discharge aperture is located within the cleaning head. In one embodiment, the cleaning tool further comprises a plurality of discharge apertures. In one embodiment, the cleaning head comprises synthetic or cellulose foam, fabric such as a woven, knitted, or nonwoven fabric, scouring webs, bristles, or a combination of one or more of these materials.

In one embodiment, the valve comprises a first part and second part moveable relative to the first part. In one embodiment, the second part twists relative to the first part. In one embodiment, the second part moves linearly relative to the first part. In one embodiment, the second part moves laterally relative to the first part. In one embodiment, the first part comprises a first passage and wherein the second part comprises the discharge aperture. In one embodiment, in the first open position of the first part and second part, the first passage and discharge aperture align. In one embodiment, in the second closed position of the first part and second part, a block covers the first passage.

In one embodiment, the locking mechanism includes a protrusion, a recess for receiving the protrusion, and a stopper adjacent the recess for containing the protrusion in the recess. In one embodiment, the protrusion is on one of the first part or second part, and the recess is on the other of the first part or second part.

### BRIEF DESCRIPTION OF THE DRAWINGS

FIG. 1 is a perspective view of one embodiment of a cleaning tool;

FIG. 2 is an exploded view of the valve and locking mechanism of the cleaning tool of FIG. 1.

While the above-identified drawings and figures set forth embodiments of the invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of this invention. The figures may not be drawn to scale.

### DETAILED DESCRIPTION

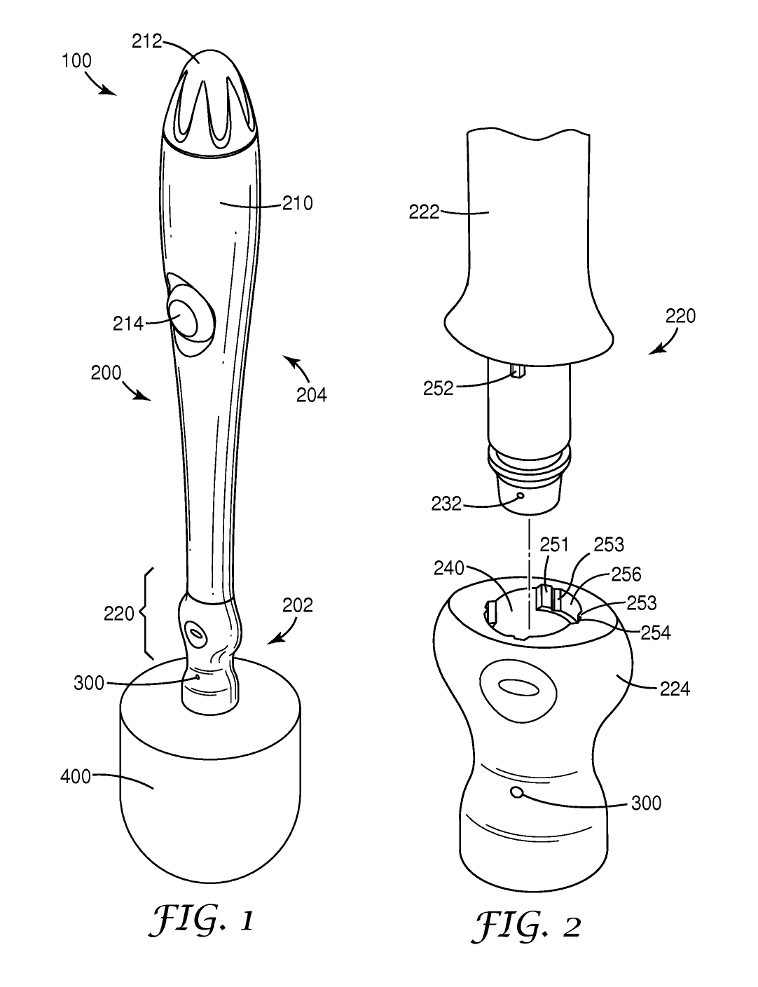

FIG. 1 is a perspective view of one embodiment of a cleaning tool 100. The cleaning tool 100 includes a handle 200 with a fluid chamber 210, a discharge aperture 300 for dispensing fluid contained within the fluid chamber 210, and a cleaning head 400. FIG. 2 is an exploded view of a valve 220 and locking mechanism that separates the fluid chamber 210 from the discharge aperture 300 to allow for controlled release of the fluid contained within the fluid chamber 210 out of the discharge aperture 300.

The handle 200 includes a fluid chamber 210 for holding a fluid, such as a cleaning chemical. The fluid chamber 210 can comprise all or a portion of the handle 200. In this embodiment, the fluid chamber 210 comprises essentially the entire handle 200. The handle includes a cap 212. The cap 212 can be removed to allow for access into the fluid chamber 210. The cap 212 can then be attached to the handle to cover the fluid chamber 210 and contain the fluid within. Any number of attachment mechanisms could be used for removably securing the cap 212 to the handle 200.

The handle 200 includes a working end 202 adjacent the cleaning head 400 and a holding end 204, which is opposite the working end 202. At the holding end 204 a user will hold the cleaning tool 100 during use. In this embodiment, the fluid chamber 210 and the cap 212 are adjacent the holding end 204 of the handle 200.

In some embodiments, such as shown in FIG. 1, the cleaning tool 100 includes an actuator 214 to aid in dispensing the fluid within the fluid chamber 210 out of the fluid chamber 210 at the discharge aperture 300. In this embodiment, the actuator 214 is in communication with the fluid chamber and is resilient and depressible. Therefore, depressing the actuator 214 displaces volume of the fluid chamber 210 and forces the fluid within the fluid chamber 210 out of the fluid chamber 210 at the discharge aperture 300.

The handle 200 is elongated and is generally longer than it is wide. In the embodiment shown, the handle 200 extends in a generally straight line from the holding end 204 to the working end 202. In this embodiment, the straight arrangement make the cleaning tool 200 well suited for cleaning the inside of contained areas like cups, bottles, tubes, sinks, or toilets. It is understood that for different applications the cleaning tool 200 could have a different shape or arrangement. For example, the handle 200 may be generally elongated, but curved near the working end 202 similar to a dishwand.

Contained within the fluid chamber 210 is a fluid. Generally, the fluid is of a low viscosity at room temperature such that with gravity alone the fluid will discharge from the fluid chamber 210 out of the discharge aperture 300 without the need for pressure or heat. For applications when the cleaning tool is used for washing dishes or other surfaces, the fluid can be a cleaning chemical. For example, in one embodiment, the fluid is a surfactant, or liquid dish soap.

The discharge aperture 300 is located adjacent the cleaning head 400. When the valve 220 is open, the discharge aperture 300 allows for the fluid contained within the fluid chamber 210 to exit the cleaning tool 100. Because the discharge aperture 300 is adjacent the cleaning head 400, the discharged fluid is then readily available for mixing into the cleaning head 400 and to be used for cleaning. In the embodiment shown in FIG. 1, the discharge aperture 300 is located at the working end 202 of the handle 200 and slightly removed from the cleaning head 400. Placing the discharge aperture 300 along the handle 200 is more easily manufactured than embedding the discharge aperture 300 with the area contained with the cleaning head 400. However, it is understood, that the discharge aperture 300 can be within the cleaning head 400. Also, it is understood that although a single discharge aperture 300 is shown, more than one discharge aperture 300 can be included.

The cleaning head 400 is located at the working end 202 of the handle 200. The cleaning head 400 is used to make contact with a surface to be cleaned. The cleaning head 400 is constructed of a material suitable for cleaning. In one embodiment, the cleaning head 400 is constructed of a material suitable for wiping, washing, scrubbing and/or scouring. In one embodiment, the cleaning material comprises more than one material. In one embodiment, the cleaning material comprises synthetic or cellulose foam, fabric such a woven, knitted, or nonwoven fabric, scouring webs, bristles, or a combination of one or more of these materials.

A valve 220 is included to allow for controlled release or containment of the fluid within the fluid chamber 210. The valve 220 is positioned between the fluid chamber 210 and the discharge aperture 300. Further, the valve 220 includes a lock mechanism that allows for the valve 220 to remain open and/or to remain closed. The valve 220 includes a first part 222 with a first passage 232 and a second part 224 with the discharge aperture 300. The first part 222 and second part 224 are movable relative to one another.

In a first open position of the first part 222 relative to the second part 224, the first passage 232 aligns with the discharge aperture 300. In the first open position, the discharge aperture 300 is in fluid communication with the fluid chamber 210 and therefore allows for fluid flow through the valve 220.

In a second closed position of the first part 222 relative to the second part 224, the first passage 232 and discharge aperture 300 do not allow for fluid flow through the valve 220. Instead, a block 240 prevents fluid communication with the fluid chamber 210 to the discharge aperture 300 and therefore stops fluid flow through the valve 220.

In one embodiment, there may be more than one first passage 232 of varying sizes to allow a user to select more or less fluid to be dispensed from the discharge aperture 300. In this embodiment, the user would rotate the second part 224 relative to the first part 222 to align the discharge aperture 300 with the appropriate passage for different rates of fluid flow.

In one embodiment, shown in more detail in FIG. 2, the first part 222 rotates relative to the second part 224 causing the first passage 232 and discharge aperture 300 to align into the first open position. Further rotation of the first part 222 relative to the second part 224 causes the first passage 232 and discharge aperture 300 to be out of alignment and therefore a block 240, in this case the inner wall, prevents fluid discharge from the first passage 232.

In one embodiment, the second part moves linearly relative to the first part. This type of arrangement is similar to the stopping valve on a bottle of liquid dish soap. In this embodiment, in the first open position, the block of the second part is linearly actuated away from the first passage of the first part so that fluid flows out of the first passage and through the discharge aperture. In the second closed position, the block of the second part is linearly actuated nearer to the first passage of the first part so that the block prevents fluid flow out of the discharge aperture.

In one embodiment, the second part moves laterally relative to the first part. In this embodiment, in the first open position, the second part is laterally actuated to the side from the first part so that fluid flows out of the first passage of the first part and through the discharge aperture. In the second closed position, the second part is laterally actuated nearer to the first part so that a block prevents fluid flow out of the discharge aperture.

Although the discharge aperture 300 and first passage 232 are show as circular, it is understood that the discharge aperture 300 and first passage 232 can comprise a number of different shapes and configurations for control of fluid flow. For example, one or both of the discharge aperture 300 and first passage 232 could be slots in horizontal or vertical positions of varying widths and lengths or could be the same shapes that align or different shapes that align.

The valve 220 includes a locking mechanism to lock the valve 220 in the first open position and/or to lock the valve 220 in the second closed position. Including a locking mechanism therefore allows the valve 220 to remain in the first open position to allow for discharge of fluid during use of the cleaning tool 100 and allows the valve 220 to remain in the second closed position to prevent discharge of the fluid. Therefore, during use or storage the user has the choice of dispensing fluid or not dispensing fluid and the locking mechanism prevents the valve 220 from inadvertently moving between the first open position and second closed position.

The locking mechanism is a mechanical interlocking mechanism between the first part 222 and the second part 224. It is understood that a number of alternative mechanical interlocking mechanisms may be used to lock the valve 220 in the first open position and/or to lock the valve 220 in the second closed position.

As shown in FIG. 2, the locking mechanism includes a protrusion 252, a flow recess 251, a stop recess 254, a stopper 253 adjacent to each recess 252, 254, and a slide surface 256 between the flow recess 521 and stop recess 254. In this embodiment, the protrusion 252 is on the first part 222. The flow recess 251, stop recess 254, slide surface 256, and stopper 253 are on the second part 224. When the protrusion 252 is in alignment with the flow recess 251, then the first passage 232 is in alignment with the discharge aperture 300. When the protrusion 252 is in alignment with the stop recess 254, then the first passage 232 is not in alignment with the discharge aperture 300, and fluid cannot flow out of the discharge aperture 300. Between the flow recess 251 and stop recess 254 is a slide surface 256 that allows for the sliding of the protrusion 252 and twisting between the first part 222 and second part 224.

The stopper 253, which is adjacent to the flow recess 251 and stop recess 254 locks the protrusion 252 in place in either the flow recess 251 or stop recess 254. However, the stopper 253 is designed to allow the protrusion 252 to pass over it with sufficient twisting forces between the first part 222 and second part 224. In this embodiment, the stopper 253 includes sloping side walls and the protrusion 252 also includes sloping side walls.

When the protrusion 252 is positioned out of the flow recess 251, then the first passage 232 is not in alignment with the discharge aperture 300. Instead, the first passage 232 is blocked by the inner walls of the second part 224. The stopper 253 also locks the protrusion 252 in place outside of the recess, and with sufficient twisting force between the first part 222 and second part 224, the protrusion 252 could be inserted again into the flow recess 251.

The cleaning 100 and its various components described herein can be constructed of various materials. For example, suitable materials include thermoplastics, elastomers, metals for the different parts or sections of the cleaning tool 100. Specifically, various elastomers, and even o-rings, could be used in and around the valve to for a better seal.

To use the cleaning tool 100, a user will remove the cap 212 and fill the fluid cavity 210 with fluid. If the user wants to have the fluid available for cleaning, the user will actuate the valve 220 to the first open position to allow for the fluid to pass out of the discharge aperture 300. In the embodiment shown in FIGS. 1-2, the second part 224 is twisted relative to the first part 222 to lock the protrusion 252 into the flow recess 251. Then, the fluid will flow to the cleaning head 400 and be available for cleaning. When the user does not want the fluid to discharge, then the user will actuate the valve 220 to the second closed position to stop the fluid flow. In the embodiment shown in FIGS. 1-2, the second part 224 is twisted relative to the first part 222 to remove the protrusion 252 from the flow recess 251, slide the protrusion 252 along the slide surface 256, and lock the protrusion 252 into the stop recess 254. The user may wish to continue cleaning without the fluid discharging or may wish to store the cleaning tool 100 for future use.

Although specific embodiments of this invention have been shown and described herein, it is understood that these embodiments are merely illustrative of the many possible specific arrangements that can be devised in application of the principles of the invention. Numerous and varied other arrangements can be devised in accordance with these principles by those of skill in the art without departing from the spirit and scope of the invention. Thus, the scope of the present invention should not be limited to the structures described in this application, but only by the structures described by the language of the claims and the equivalents of those structures.

1. A cleaning tool comprising:
a handle comprising a fluid chamber and a discharge aperture, wherein the handle has a working end and a holding end;
a cleaning head secured to the working end of the handle and adjacent the discharge aperture;
a valve separating the fluid chamber from the discharge aperture, actuatable between a first open position and a second closed position, wherein in the first open position, the fluid chamber is in fluid communication with the discharge aperture; and
a locking mechanism at the valve and handle to lock the valve in the first open position or the second closed position.

2. The cleaning tool of claim 1, wherein the handle extends in a straight line from the holding end to the working end.

3. The cleaning tool of claim 1, wherein the handle further comprises an actuator for displacing fluid from within the fluid chamber.

4. The cleaning tool of claim 1, wherein the discharge aperture is located on the handle and removed from the cleaning head.

5. The cleaning tool of claim 1, wherein the discharge aperture is located within the cleaning head.

6. The cleaning tool of claim 1, further comprising a plurality of discharge apertures.

7. The cleaning tool of claim 1, where in the cleaning head comprises synthetic or cellulose foam, fabric such a woven, knitted, or nonwoven fabric, scouring webs, bristles, or a combination of one or more of these materials.

8. The cleaning tool of claim 1, wherein the valve comprises a first part and second part moveable relative to the first part.

9. The cleaning tool of claim 1, wherein the second part twists relative to the first part.

10. The cleaning tool of claim 1, wherein the second part moves linearly relative to the first part.

11. The cleaning tool of claim 1, wherein the second part moves laterally relative to the first part.

12. The cleaning tool of claim 1, wherein the first part comprise a first passage and wherein the second part comprises the discharge aperture.

13. The cleaning tool of claim 1, wherein in the first open position of the first part and second part, the first passage and discharge aperture align.

14. The cleaning tool of claim 1, wherein in the second closed position of the first part and second part, a block covers the first passage.

15. The cleaning tool of claim 1, wherein the locking mechanism includes a protrusion, a recess for receiving the protrusion, and a stopper adjacent the recess for containing the protrusion in the recess.

16. The cleaning tool of claim 1, wherein the protrusion is on one of the first part or second part, and the recess is on the other of the first part or second part.
